(19) United States
(12) Patent Application Publication
(10) Pub. No.: US 2025/0121339 A1
(43) Pub. Date: Apr. 17, 2025

(54) DISPERSING UNIT

(71) Applicant: NETZSCH-Feinmahltechnik GmbH, Selb (DE)

(72) Inventor: Wolfgang Stadlbauer, Thierstein (DE)

(21) Appl. No.: 18/685,265

(22) PCT Filed: Aug. 16, 2022
(86) PCT No.: PCT/DE2022/100600

§ 371 Date: Feb. 21, 2024

(30) Foreign Application Priority Data
Aug. 30, 2021 (DE) 10 2021 122 325.3

(51) Int. Cl. B01F 27/1152; B01F 27/2123; B01F 27/271

(52) U.S. Cl. CPC B01F 27/1152; B01F 27/2123; B01F 27/271; B01F 2215/0481

(57) ABSTRACT

A dispersing unit for dispersing a feed material in a dispersant, including a stationary dispersing basket, the lateral surface of which has outlet openings and one end of which is preferably at least partly closed and into which a shaft stub of a drive shaft protrudes, wherein, within the dispersing basket, the shaft stub bears a dispersing disk, which rotates during operation and thereby sucks feed-material-laden dispersant into the region between the dispersing disk and the closed end of the dispersing basket and discharges the feed-material-laden dispersant from said region largely via the outlet openings in the lateral surface of the dispersing basket

### TECHNICAL FIELD

The invention relates to a dispersing unit for dispersing a feed material according to the preamble of claim 1, a dispersing unit according to the preamble of claim 3 as well as a dispersing device according to the preamble of claim 13.

### BACKGROUND

Dispersing devices are used to create dispersions, thus heterogenous mixtures of at least two materials, which cannot be dissolved or not completely dissolved in each other.

The dispersing unit thereby serves the purpose of setting the materials in motion in such a way that a first material is distributed as evenly as possible in a second material, and to break open agglomerates of the material to be distributed. The material, which is distributed in the other material, will be referred to below as feed material. The material, in which the feed material is distributed, will be referred to below as dispersant.

The feed material as well as the dispersant can generally assume all three agglomerate states. It is not a dispersion only when both are gaseous. The dispersions represented most frequently in industrial applications are emulsions (liquid/liquid) as well as suspensions (solid/liquid).

In the case of the suspensions, the solid feed materials are typically fine and powdery. For the most part, the particle size is smaller than 1 mm, often even smaller than 1/10 mm

Last but not least in the case of creating a dispersion from a liquid dispersant and an essentially solid feed material, the dispersant is filled into a container together with the feed material. There, the feed material and the dispersant are set in motion in such a way that the feed material is evenly distributed in the dispersant.

Conventional dispersing units typically consist of a disk driven by a drive shaft, which has tooth-like flow elements on its outer circumference and which circles freely, without basket, in the mass to be dispersed. The flow elements often protrude orthogonally or almost orthogonally from the remaining disk and effect a turbulence of the fluid located in the region of the rotating disk. Due to the rotation of the disk in the container, which is filled with dispersant and feed material, the entire container content is then set in motion. The feed material is distributed in the dispersant thereby. The degree of mixing, however, decreases thereby with increasing distance from the rotating disk. Agglomerates of feed material particles, which are in particular located on the edge of the container, are not separated or only to a limited extent. In order to obtain a finest possible distribution of the feed material in the dispersant, a relatively long mixing duration is thus required. In addition, such conventional dispersing units without a basket are dependent on the mass to be dispersed having a certain viscosity that is not too low in order to be able to introduce the shear forces required for progressive dispersion into the mass to be dispersed to a sufficient degree by means of disc rotation.

Even in the case of a high viscosity of the mass to be dispersed, the shearing forces in the case of the dispersing units that operate without a basket and only with a circulating disk are no longer sufficient, however, in order to also comminute granular, coarsely granular or even fragmented feed product instead of powdery feed product.

Dispersing units are thus also known, in the case of which a rotor rotates in a cage-like basket. The rotor is thereby typically designed so that it conveys the dispersant located outside the basket into the basket together with the feed material. The dispersant conveyed into the basket together with the feed material is then pushed through the openings of the basket together with the feed material. This results in a comminution of the particles of the feed material at the openings of the cage. In the case of dispersing units of this type, it is generally considered to be important to form a narrow sealing gap of smaller than 2 mm, mostly even only in the range of 0.5 to 1 mm, between the rotor and the basket. This takes place in order to keep the flow-through low in this region. In addition, a rotor is often installed, which predominantly or completely covers or passes over, respectively, the perforated surface on the cage. Even though dispersing units of this type have the advantage that they create a relatively strong flow in the direction of the basket, so that possible feed material agglomerates, which are initially located on the edge of the container, are sucked in and are comminuted, the agglomerates can only be separated to a certain degree as a function of the size of the cage openings. Even though smaller openings generally lead to a finer separation, smaller openings are simultaneously associated with a larger flow resistance and thus with a lower suction effect. Cage openings, which are too small, may additionally lead to an accumulation of feed material particles and ultimately to the clogging of the cage.

### SUMMARY

In view of this, it is the object of the invention to specify a dispersing unit, by means of which a high suction effect can be realized with a simultaneously high degree of separation of feed material agglomerates.

According to the invention, this problem is solved with the features of the main claim directed at the dispersing unit.

The problem is accordingly solved by means of a dispersing unit for dispersing a feed material in a dispersant. The dispersing unit comprises a dispersing basket, which is stationary even during operation, the jacket surface of which has outlet openings. In some application cases, the upper front side of the dispersing basket has apertures or slits, the upper front side of the dispersing basket could also be completely open in some cases. However, the following preferably applies: A front side of the dispersing basket is predominantly, essentially or completely closed. A shaft stub of a drive shaft protrudes into the dispersing basket. The shaft stub thereby carries a dispersing disk within the dispersing basket. The dispersing disk rotates during operation and thus sucks feed material-laden dispersant into the region between the dispersing disk and the closed front side of the dispersing basket. The dispersing disk predominantly conveys the sucked-in dispersant out of this region again via the outlet openings in the jacket surface of the dispersing basket.

The dispersing unit is preferably characterized in that the dispersing basket is open on its front side facing away from the drive shaft-completely, otherwise at least essentially or predominantly, respectively.

The dispersing unit is further characterized in that the clear radial distance between the largest outer circumference of the dispersing disk or preferably the rim ring thereof, respectively, and the inner circumferential surface of the dispersing basket is so large that a gap is formed, via which a more than only insignificant portion, preferably at least 15%, preferably at least 25% of the dispersant conveyed into the dispersing basket can flow out of the dispersing basket again. The dispersing disk is thereby constructed so that the medium conveyed into the dispersing basket can essentially flow through the dispersing disk or the central region thereof, respectively. The dispersant flowing into the dispersing basket and the dispersant flowing out of the dispersing basket past the dispersing disk on the outer circumference in the axial direction of the dispersing disk thus do not obstruct one another. The flow in the direction axially towards the dispersing disk has the advantage that feed material particles, which may have accumulated on the dispersing basket, are entrained by it. A clogging of the outlet openings of the cage is thus counteracted. Accumulated particles can also be entrained by means of this flow.

An annular flow in the circumferential direction of the dispersing disk additionally results in the gap between the dispersing disk and the inner jacket surface of the dispersing basket. This annular flow results in that a portion of the feed material, which reached into the gap together with the dispersant, is accelerated as a result of centrifugal forces in the direction of the inner jacket surface of the dispersing basket. Feed material agglomerates then collide with the inner jacket surface of the dispersing basket or with the reveal surfaces of the openings in the jacket surface of the dispersing basket and are separated or virtually crushed thereby, respectively.

That being said, the dispersing disk preferably does not cover or pass over the perforated surface of the dispersing basket, respectively, or preferably at least only to a smaller extent.

Due to the flow ratios according to the invention, an increased number of collisions, which have a crushing effect, is thus generated, with the reveal surfaces and openings in the jacket surface of the dispersing basket but also with the teeth or other impact elements of the dispersing disk.

Due to this, good dispersing results are achieved by means of the dispersing unit according to the invention even in the case of coarser, thus granulated or even fragmented feed product, namely even when the viscosity of the mass to be dispersed is comparatively low.

The term “feed material-laden” describes the state of the dispersant, in which feed material is already contained in the dispersant, but the feed material was not yet distributed or comminuted.

The term “feed material agglomerates” does not necessarily only describe solid materials but can refer to an accumulation of liquid or predominantly liquid materials.

There is a number of options for designing the invention so that its effectiveness or usability is even further improved.

It is thus particularly preferred that the dispersing unit has a dip tube, in which the driven drive shaft can rotate. The dip tube thereby carries the dispersing basket.

The dip tube is stationary and prevents that the rotating drive shaft entrains dispersants outside of the cage, ineffectively whisks them and radially centrifuges or sprays them. This results in an increase of the efficiency of the dispersing unit.

In a further preferred embodiment, the wheel body comprises spokes and preferably a rim ring. Ideally, the wheel body comprises four spokes, to decrease the cavitation risk in the spoke region preferably only three spokes. Teeth are attached in the region of the radially outer end thereof.

The wheel body, of which the dispersing disk consists, is thereby embodied as hub, which, in the mounted state, is fastened to the drive shaft, which protrudes into the dispersing basket. In the event that the wheel body has a rim ring, the teeth are attached in the region of the radially outer outer circumferential surface of the rim ring. The spokes make it possible for the feed material-laden dispersant to flow through the dispersing disk into the dispersing basket in the central region in the axial direction of said dispersing disk.

The teeth effect an additional comminution of the feed material agglomerates. The comminution takes place, on the one hand, when agglomerates impinge on the teeth, which rotate with the dispersing disk. The teeth additionally effect a turbulence of the feed material-laden dispersant, which is located in the vicinity of the gap between dispersing disk and dispersing basket. The feed material agglomerates are thus thrown against one another and against the inner jacket surface of the dispersing basket or the reveals of its openings, respectively, and are separated. In order to create a corresponding flow, at least a partial region of the teeth ideally runs parallel or approximately parallel to the longitudinal axis of the dispersing disk. The teeth thereby preferably alternately protrude from the dispersing disk in opposite directions. It is also conceivable thereby that the teeth have different geometries or different sizes.

The wheel body ideally comprises a plate-like wheel disk comprising notches. The notches provide for the passage of the dispersant, which is laden with feed material.

It is advantageous in particular to design the notches so that a rotational movement of the dispersing disk effects a conveyance of the feed material-laden dispersant into the desired region.

In a further preferred embodiment, the spokes or notches are positioned in the manner of blades. They are preferably positioned at an angle of between 27° and 33° to the perpendicular on the drive shaft longitudinal axis, namely in such a way that they pump the dispersant essentially or at least predominantly in the direction of the drive shaft longitudinal axis, into the dispersing basket.

When the preferred, corresponding dimensioning of the flow paths was implemented, then the spokes designed in the manner of blades pump more dispersant together with the feed material contained therein into the region between the closed front side of the dispersing basket and the dispersing disk than can be output to the outside through the outlet openings in the jacket of the dispersing basket.

As a result, a good portion of the dispersant is not pressed out of the dispersing basket through the window in the jacket surface of the dispersing basket but instead through the gap between the outer circumference of the dispersing disk and the inner circumference of the dispersing basket.

Note: In principle, as much of the material sucked in as possible should be pressed through the windows in the basket.

The resulting higher concentration of feed material-agglomerate mixture reaches the area of action of the teeth of the dispersing disc, where shattering takes place. The crushing takes place either by means of the teeth themselves or in that the solid material is thrown against the reveal of an outlet opening by means of the contact with a tooth or by means of the indirect effect of a tooth.

The ratio between the largest outer diameter GAD of the dispersing disk, which preferably terminates with a rim ring in the region of its outer circumference, and the largest outer diameter GAS, which describe the rotating exposed ends of the spokes, preferably fulfills the following relationship: GAD/GAS=1.48 to 1.55.

In the case of a ratio of this type, a good conveying capacity of the dispersing disk, based on the dispersant conveyed into the dispersing basket by the dispersing disk, is ensured. In a further preferred embodiment, the continuous clear height HA of the outlet openings or at least of those outlet openings, which gird the dispersing disk as a row of several outlet openings running in the circumferential direction, is more than only insignificantly larger than the height h of the dispersing disk. Ideally, the height HA is larger at least by the factor of 2.2 than the height h of the dispersing disk. Preferably, it is larger at least by the factor of 4 and, in the optimal case, at least by the factor of 6.

In a further preferred embodiment, the clear radial distance between the largest outer circumference of the dispersing disk and the inner circumferential surface of the dispersing basket is so large that a gap is formed, via which large particles or agglomerates also find their way into the dispersing basket.

It can generally be said that the parameters of the dispersing basket and of the dispersing wheel are selected so that the flow-through of the dispersing basket is accomplished, if possible, in that the dispersant together with the feed material contained therein enter into the dispersing basket via the at least one free front side and leave it again essentially via its perforated circumferential jacket surface, instead of via the front surfaces.

The clear radial distance between the outer circumference of the dispersing wheel and the inner circumferential jacket surface of the dispersing basket is thereby preferably at least 10 mm, preferably at least 20 mm and ideally maximally 35 mm or 30 mm, respectively.

In a further conceivable embodiment, the dispersing basket is closed on its closed front side by a conical or parabolic reflector body.

The reflector body deflects the volume flow, which is conveyed by the dispersing disk in the axial direction into the space between the dispersing disk and the dispersing basket closed by the reflector body, preferably in the direction of its center. This leads to a particularly intensive turbulence and thus to a finer distribution of the feed material in the dispersant.

In a further preferred embodiment, the teeth are carried by a rim ring, with which they form a toothed ring. The latter is preferably connected in a replaceable manner, mostly in a destruction-free replaceable manner, to the spokes of the dispersing disk.

Depending on the application, toothed rings with different tooth geometries or from different materials can thus be attached to the dispersing disk. In the case of signs of wear, the toothed ring can additionally be replaced without having to change the entire dispersing disk.

The dispersing device preferably has a dispersing container. The dispersing container, in the simplest case a suitably coordinated bucket, holds the dispersant and the feed material. The dispersing basket is completely immersed into the dispersing container during operation. The dispersing device is characterized in that the outer diameter of the dispersing basket is exactly, essentially or least approximately 0.5-times to 0.6-times the inner diameter of the dispersing container.

In the event that the dispersing container is non-circular, the outer diameter of the dispersing basket refers to the central outer diameter thereof, and the inner diameter of the dispersing container to the central inner diameter thereof.

Protection is also claimed for a dispersing unit for dispersing a feed material in a dispersant comprising a dip tube. A motor-driven drive shaft can rotate in the dip tube. The dip tube thereby carries a dispersing basket, which is stationary even during operation. The jacket surface of the dispersing basket has outlet openings. The front side of the dispersing basket facing the dip tube is predominantly, essentially or completely closed. A shaft stub of the drive shaft additionally protrudes into the dispersing basket. The shaft stub thereby carries a dispersing disk. The dispersing unit is characterized in that the dispersing basket is open completely or at least essentially on its front side facing away from the dip tube. The height H, which measures the extension of the dispersing basket along the drive shaft longitudinal axis L, is significantly larger, thus at least by the factor of 2.5 or preferably at least by the factor of 4-6, than the largest height h of the dispersing disk. The dispersing disk consists of a wheel body, which carries teeth on its outer circumference.

The dip tube prevents that the rotating drive shaft entrains dispersant outside of the cage, ineffectively whisks it and centrifuges or sprays it radially. It is ensured thereby that a radial acceleration of the feed material-laden dispersant takes place only or at least predominantly only in the region of the teeth of the dispersing disk. This results in a higher speed difference between the dispersant and the feed material agglomerates entrained by said dispersant and thus in a high impact effect or a better separation of the agglomerates, respectively.

Protection is furthermore claimed for a dispersing system, which comprises a dispersing unit according to claim 11. The dispersing system is characterized in that it comprises at least a second, alternatively mountable tooth ring. The teeth of the at least one second toothed ring have a different tooth geometry than the teeth of the first tooted ring.

Protection is additionally claimed for a dispersing device comprising a dispersing unit according to one of the already established claims. The dispersing device is characterized in that it has a high-speed drive. The latter allows the dispersing disk to rotate at a speed of more than 18 m/s and ideally up to 20 m/s in the region of its outer circumference, in some cases, which are then only optimal to a limited extent, up to 25 m/s.

### BRIEF DESCRIPTION OF THE DRAWINGS

FIGS. 1-2 show the overall construction of the dispersing unit according to a first exemplary embodiment.

FIGS. 3-4 clarify the mode of operation of the dispersing disk in combination with the dispersing basket, by means of the first exemplary embodiment, representative for all exemplary embodiments.

FIGS. 5-9 show the construction of the dispersing basket and of the dip tube, by means of the first exemplary embodiment, representative for all exemplary embodiments.

FIGS. 10-12 show the construction of the dispersing disk, by means of the first exemplary embodiment, representative for all exemplary embodiments.

FIGS. 13 and 14 show a second exemplary embodiment, which is characterized by its dispersing basket, the position of which can be adjusted, and its optional outer centrifugal disk.

FIG. 15 shows a third exemplary embodiment, which is characterized by its additional centrifugal disk on the inside of the basket.

FIG. 16 shows a fourth exemplary embodiment, which is characterized by a perforated front-side cover of the dispersing basket.

### DETAILED DESCRIPTION

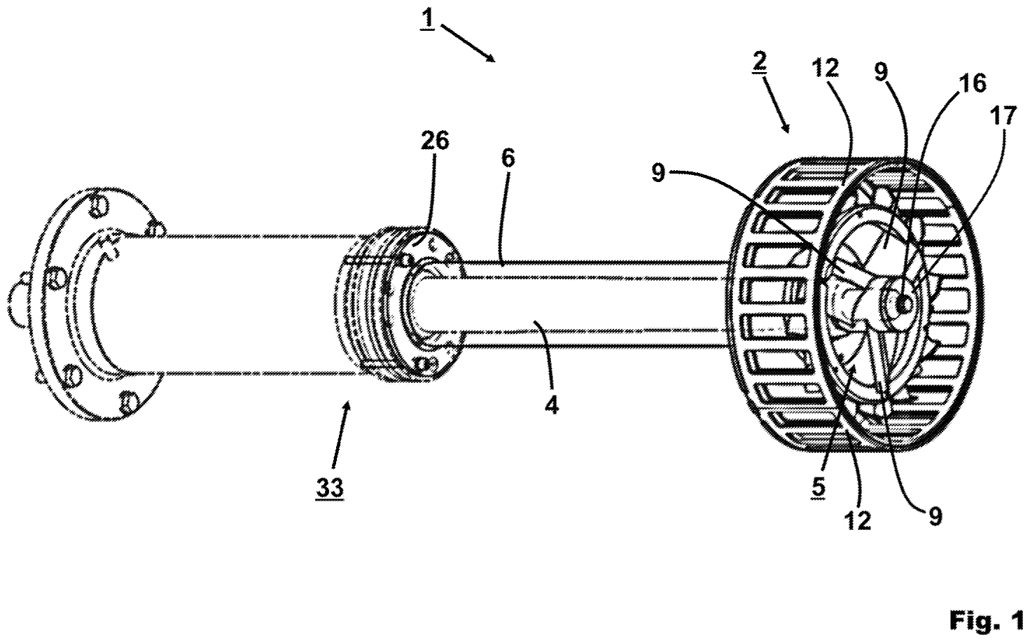

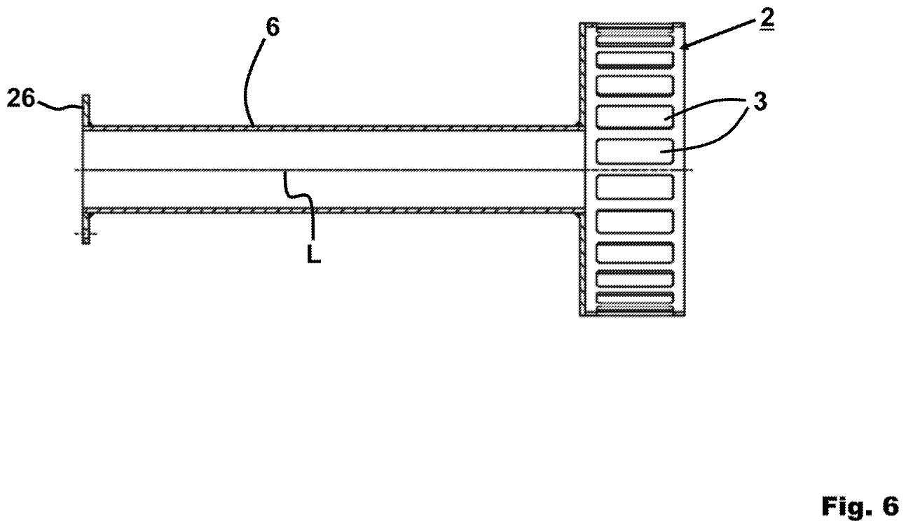

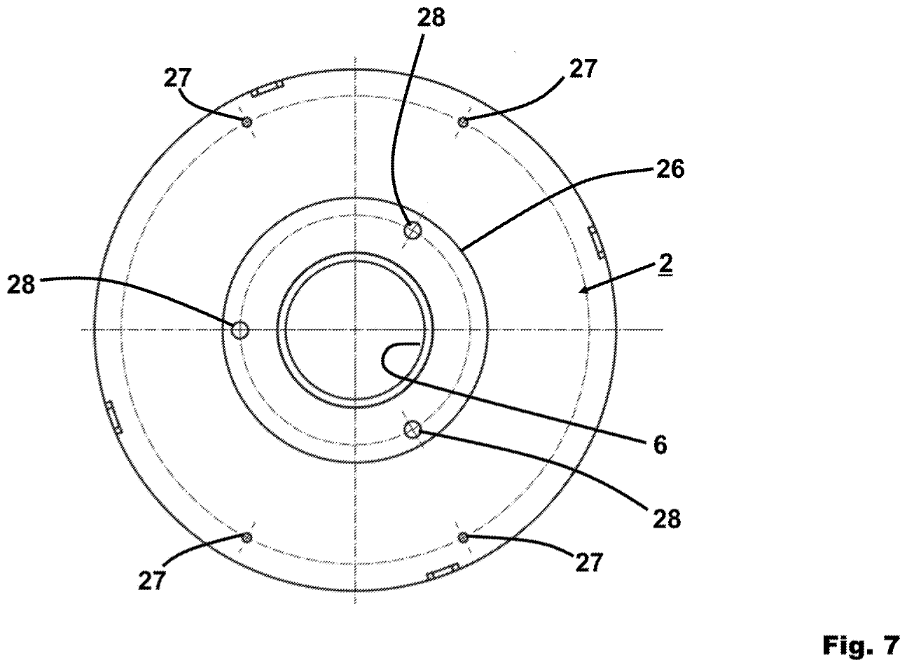

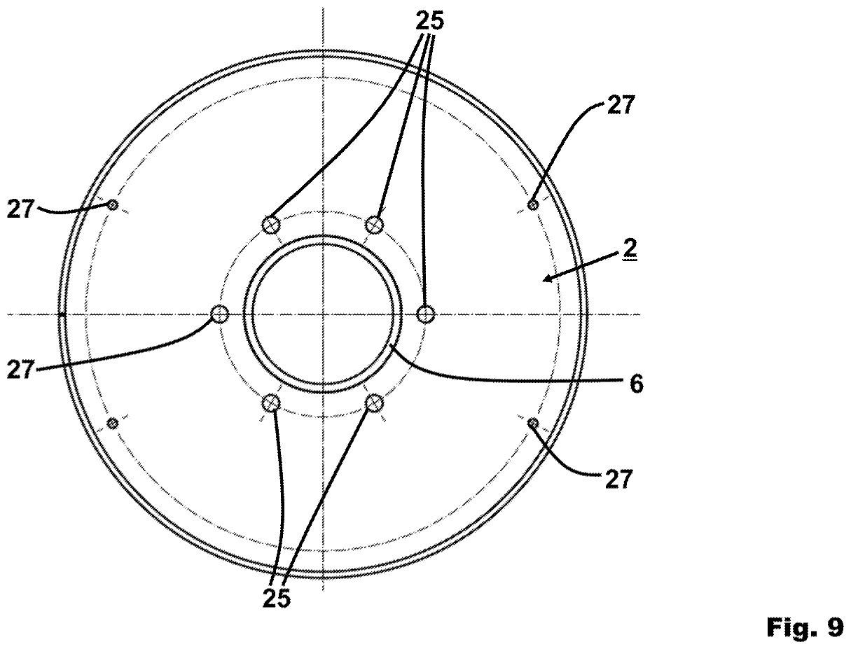

The mode of operation of the dispersing unit according to the invention will be by means of a first exemplary embodiment on the basis of FIGS. 1 to 12.

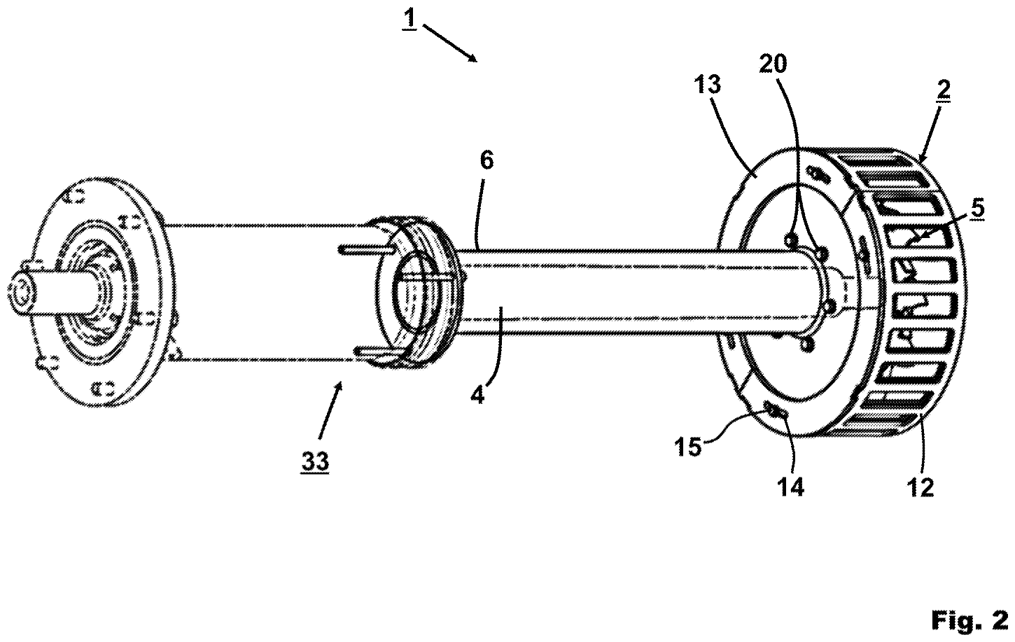

The basic construction of the dispersing unit 1 can be described by means of FIGS. 1 and 2. For the sake of clarity, not all elements are provided with reference numerals thereby.

During operation, the dispersing unit 1 is located in a container with the materials to be dispersed, whereby the dispersing basket 2 together with the dispersing disk 5 located therein is immersed completely into the dispersant. Viewed as a whole, an ensemble is created in this way, which can be referred to as dispersing unit and which will be discussed briefly once again at the very end of the description.

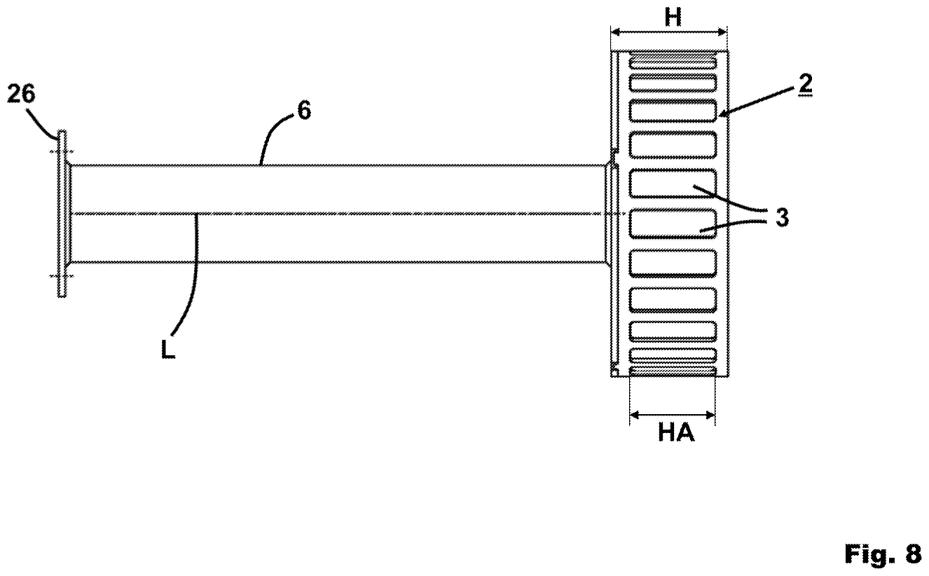

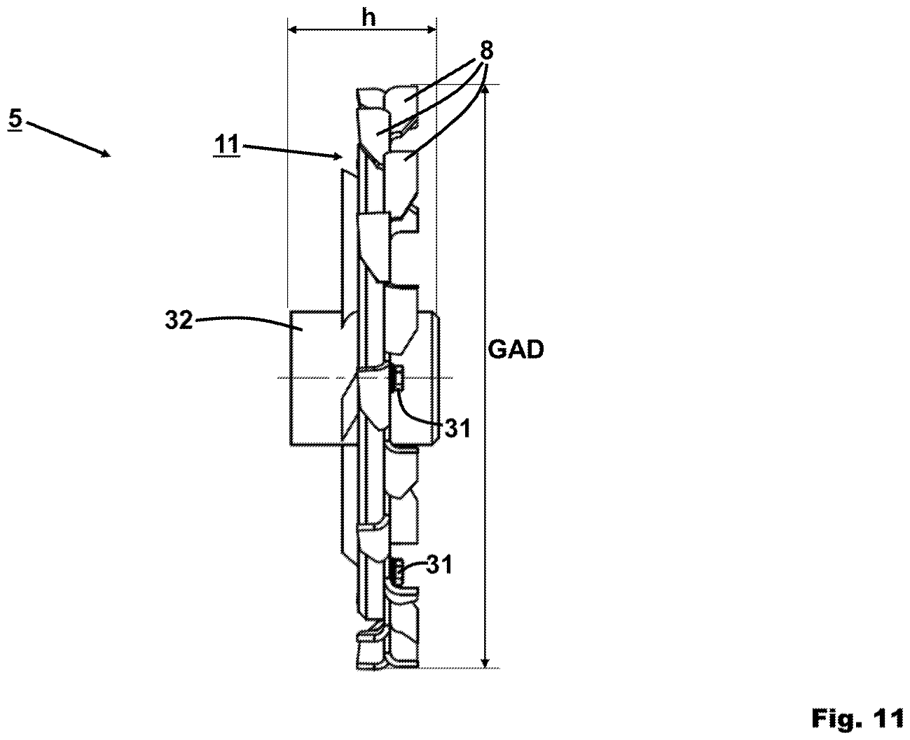

The optional dip tube 6, which is connected to the dispersing basket 2, is fastened with the flange 26 to the housing section 33, which is generally not in contact with dispersant during operation. The dip tube generally forms a torque support for the dispersing basket, holds it in a rotationally fixed manner even under the strain of the rotating gush of liquid. The drive shaft 4, which is not illustrated but which is suggested with dashed lines, runs within the dip tube 6. On the end of the tip tube 6 facing the dispersing basket 2, said drive shaft protrudes from said dip tube and into the dispersing body 2. The dispersing disk 5 is attached to the section of the drive shaft 4 protruding into the dispersing basket 2. The height H (see FIG. 8) of the dispersing basket 2 is significantly larger thereby than the maximum height h (see FIG. 11) of the dispersing disk 5. It is thus ensured that, in the mounted state, the dispersing disk 5 is located completely in the interior of the dispersing basket 2.

During operation, the rotational movement of the drive shaft 4 is transferred to the dispersing disk 5. The feed material-laden dispersant located in the region of the front side of the dispersing basket 2 facing away from the dip tube 6 is thereby conveyed via the spokes 9 through the dispersing disk 5 into the region between the dispersing disk 5 and the closed front side of the dispersing basket 2 facing the dip tube 6. In order to create a corresponding conveying effect, the spokes 9 are formed in the manner of blades. The majority of the feed material-laden dispersant conveyed into the dispersing basket 2 leaves the dispersing basket 2 via the outlet openings 3. The clear height HA (see FIG. 8) of the outlet openings 3 is thereby significantly larger than the maximum height h of the dispersing disk 5. Some of the feed material agglomerates contained in the dispersant thereby impinge on the webs between the outlet openings 3 of the dispersing basket 2. The agglomerates are separated by the impingement.

In order to increase the degree of the separation, the clear width of the outlet openings 3 can be varied. For this purpose, the cylinder jacket surface of the dispersing basket 2, which is provided with the outlet openings 3, is equipped with a basket wall reinforcement 12. The basket wall reinforcement 12 is likewise provided with outlet openings 3, the geometry of which matches those of the dispersing basket 2. In order to change the clear width of the outlet openings 3, the basket wall reinforcement 12 can be rotated around the longitudinal axis L of the drive shaft 4. If the basket wall reinforcement 12 is in the desired position, the holding disk 13, which is connected in a rotationally fixed manner to the basket wall reinforcement 12, is fixed against a further rotation by means of the clamping screws 15. The maximum angle of rotation, about which the basket wall reinforcement 12 can be rotated about the longitudinal axis L of the drive shaft 4, is determined by the length of the curved elongate holes 14.

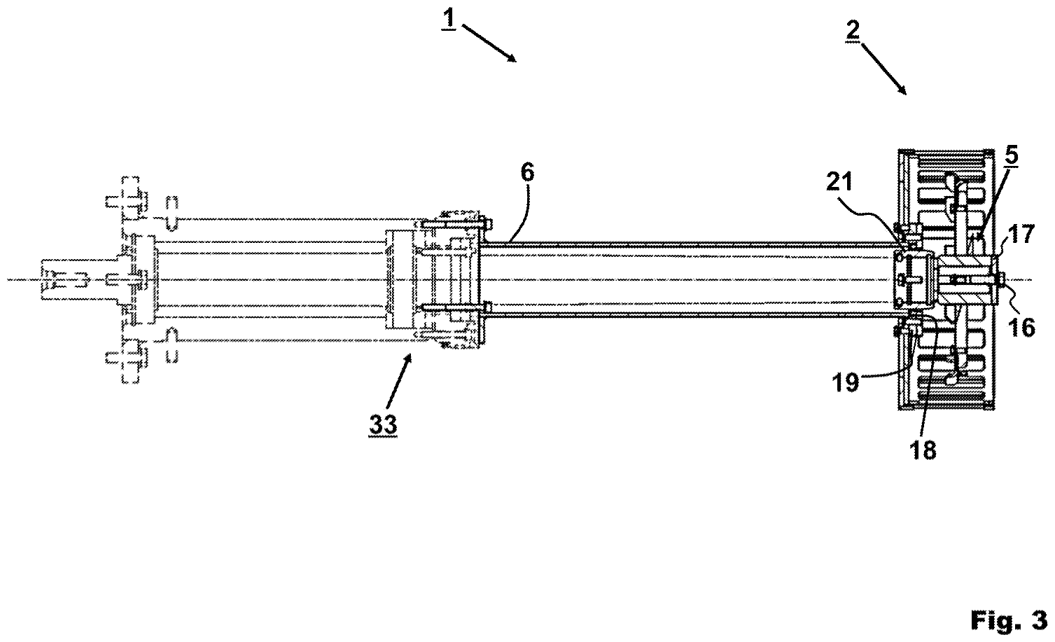

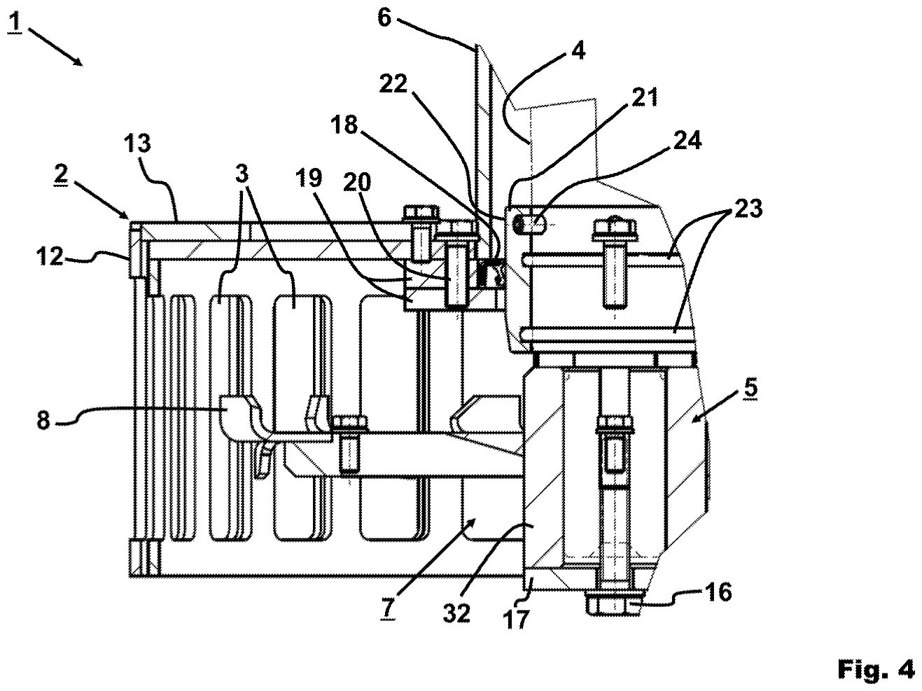

The mode of operation of the dispersing disk 5 in combination with the dispersing basket 2 can be described by means of FIGS. 3 and 4.

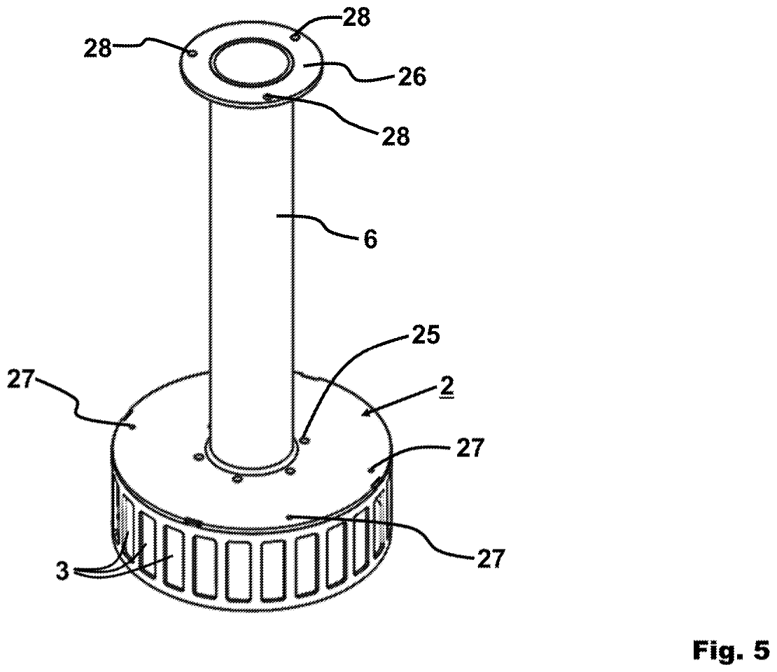

As described above, the majority of the dispersant conveyed into the dispersing basket 2 by means of the dispersing disk 5 leaves the dispersing basket 2 via the outlet openings 3. However, a gap, via which a not insignificant portion of the feed material-laden dispersant leaves the dispersing basket 2, is located between the largest outer circumference GAD of the dispersing disk 5 and the inner circumferential surface of the dispersing basket 2. Said gap can be seen well by means of FIGS. 4 and 5.

The geometry of the dispersing disk 5 and of the dispersing basket 2 is adapted to one another so that the dispersing disk 5 conveys more feed material-laden dispersant into the region between it and the closed front side of the dispersing basket 2 facing the dip tube 6, than can flow out from the dispersing basket 2 through the outlet openings 3. As a result, the portion of the feed material-laden dispersant, which does not leave the dispersing basket 2 via the outlet openings 3, is pushed into the region of the gap between the dispersing disk 5 and the inner jacket surface of the dispersing basket 2.

A flow is thereby created in the direction parallel to the longitudinal axis L of the drive shaft 4, which increasingly conveys solid materials or feed material agglomerates, respectively, into the effect region of the teeth 8 of the dispersing disk 5. This effect can additionally be intensified by the already described variability of the clear width of the outlet openings 3 of the dispersing basket 2. The teeth 8 rotating with the dispersing disc 5 then either collide with the feed material agglomerates or cause a turbulence that transports the agglomerates towards the embrasures of the openings in the outer surface of the dispersing basket or webs between the outlet openings 3. A crushing of the agglomerates takes place in both cases.

In combination with the holding disk 17, the dispersing disk is fastened to the drive shaft 4 by means of the fastening screw 16. The protection against rotation of the dispersing disk 5 on the drive shaft 4 takes place by means of a feather key connection.

To prevent that dispersant reaches into the interior of the dip tube 6, the dip tube 6 is optionally sealed by means of a radial shaft seal ring 18 or by means of a gap seal. A further sealing option will be mentioned later as part of the variations. The mounting of the radial shaft seal ring 18 takes place via the positioning rings 19. They are fastened to the dispersion basket 2 by means of the fastening screws 20. The running surface 22 for the sealing lip of the radial shaft seal ring 18 is provided by the sleeve 21. The sleeve 21 is pushed onto the drive shaft 4 and is clamped there by means of screws, which are screwed into the threaded bores 24. To seal the gap between the sleeve 21 and the drive shaft 4, two grooves 23 are provided in the sleeve 21, into which an O ring can be inserted in each case.

The construction of the dispersing basket 2 (without the basket wall reinforcement 12) as well as the connection of the dispersing basket 2 to the dip tube 6 is illustrated in FIGS. 5 to 9. The outlet openings 3 and the bores 25 are provided with reference numerals only in an exemplary manner in FIG. 5.

The dip tube 6 is connected to the dispersing basket 2 as well as to the flange 26 via a respective circumferential weld seam. Three through bores 28 for fastening the flange 26 to the housing section 33 of the dispersing device are provided in the flange 26. The closed front side of the dispersing basket 2 facing the dip tube 6 is welded to the remaining dispersing basket 2. It is also conceivable, however, to adhere them or to releasably connect them (for example via a screw-connection) or to manufacture the dispersing basket 2 in one piece, respectively. Four threaded bores 27 for the clamping screws 15 as well as six through bores 25 for the fastening screws 20 are additionally provided on the closed front side of the dispersing basket 2 facing the dip tube 6.

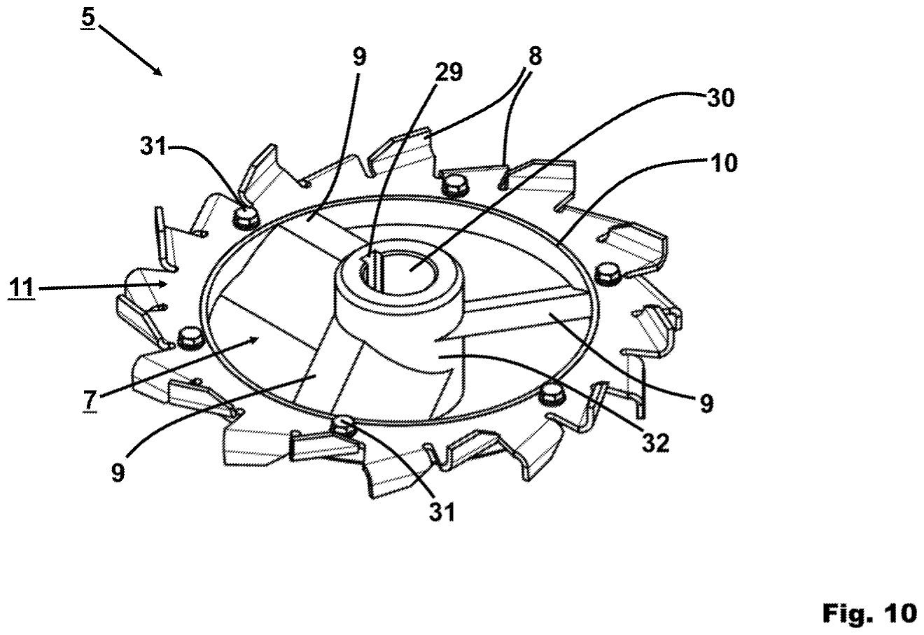

The construction of the dispersing disk 5 is clarified by means of FIGS. 10 to 12. The dispersing disk 5 comprises a wheel body 7, a rim ring 10 adjoining thereon and a toothed ring 11 attached to the rim ring 10 and provided with the teeth 8. It is also conceivable thereby that the toothed ring 11 is formed from the rim ring 10, to which the teeth 8 are fastened directly. The wheel body 7 of the dispersing disk 5 is formed by the hub 32 and the spokes 9. In the center, the dispersing disk 5 has the hub 32, which is pushed with its bore 30 onto the drive shaft 4. To transfer the rotational movement of the drive shaft 4 to the dispersing disk 5, a feather key groove 29 is provided in the hub 32, which, in the mounted state, engages with a corresponding feather key. Starting at the hub 32 in the center of the dispersing disk 5, three spokes 9 run radially to the outside. They are designed in the manner of blades, so that they convey the dispersant located below the dispersing disk 5 into the region above the dispersing disk 5 in response to a rotation of the dispersing disk 5. The toothed ring 11 of the dispersing disk 5 is connected to the rim ring 10 via the holding screws 31.

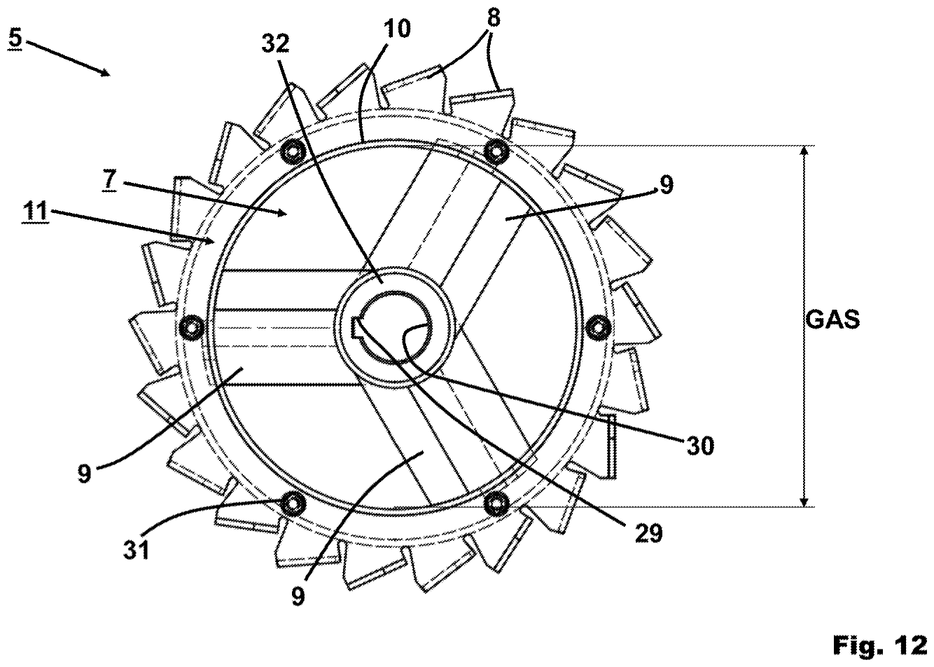

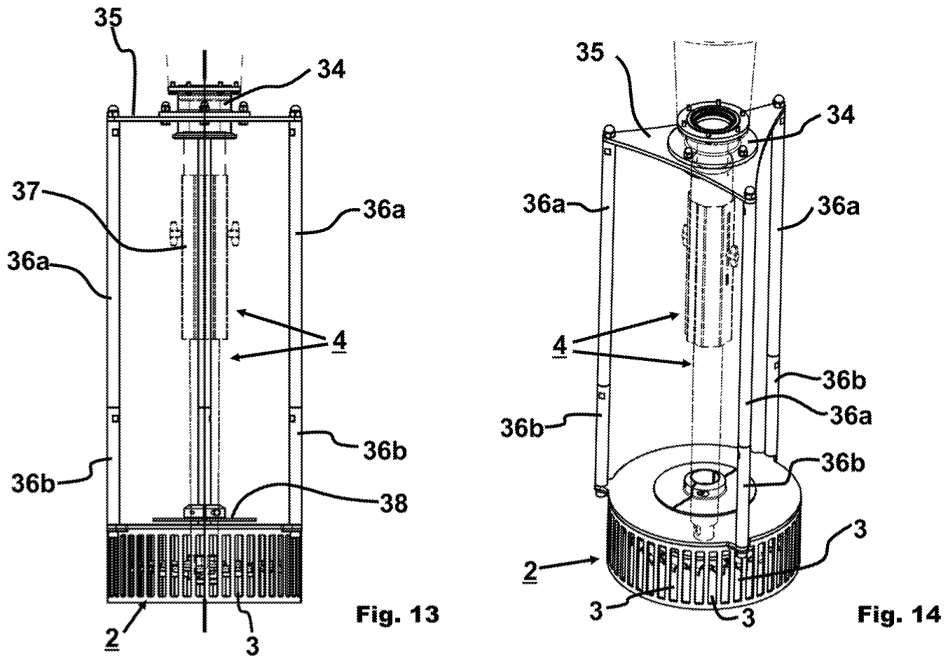

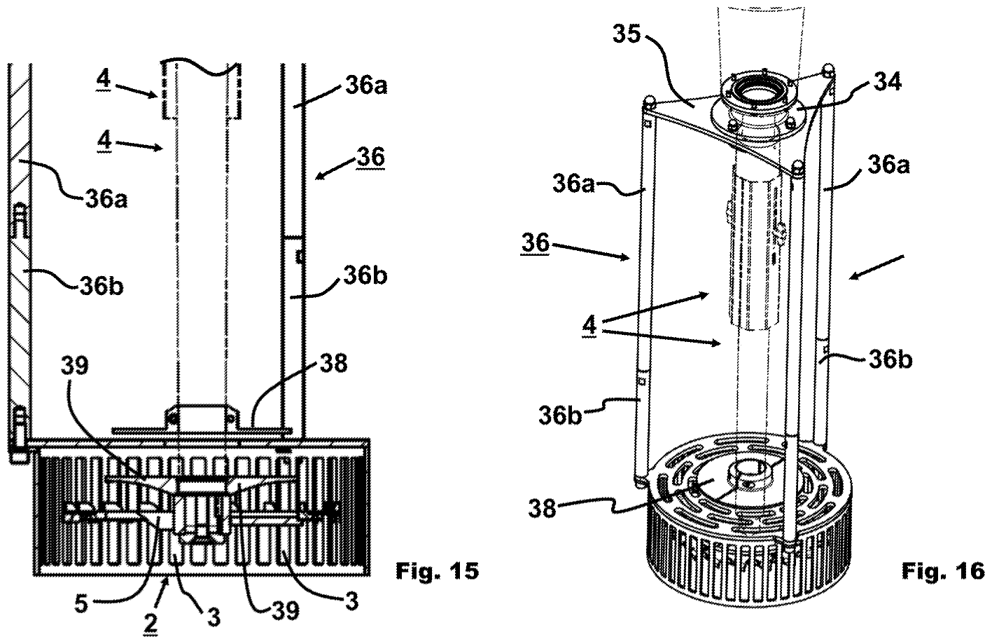

FIGS. 13 to 16 show a second exemplary embodiment, which is modified under certain technical aspects.

However, the statements already made above for the first exemplary embodiment also apply accordingly for this second exemplary embodiment—unless stated otherwise expressly in the following description.

This exemplary embodiment is characterized in that the immersion depth of the dispersing basket 2 can be varied—measured from a specified vessel edge.

A flange collar 34, which can be fixed in a stationary manner, is provided for this purpose. It carries a multi-sided cantilever, here in the shape of triangular cantilever 35. Holding rods 36 are fastened in each case to the cantilever or triangular cantilever, respectively. The other end thereof is in each case anchored to the dispersing basket 2.

The holding rods 36 are typically embodied in a dismountable or telescopic manner. In the case of this exemplary embodiment, each holding rod consists of a first section 36a and a second section 36b. On its first end, each holding rod or each of its sections 36a, 36b advantageously has a bolt thread and a nut thread on its second end. A linking to a holding rod 36 of the desired length can thus be carried out without any problems. In cases, in which it is desired to allow the dispersing basket 2 to be immersed only less deeply, the second sections 36b are omitted or unscrewed, respectively, and the dispersing basket 2 is anchored directly to the end of the first section 36a.

The drive shaft 4 is simultaneously likewise embodied to be capable of being changed in length, thus for instance so as to be capable of being telescoped. It can thus be shortened accordingly by pushing together. The clamping mechanism 37 for fixing the correspondingly telescoped drive shaft is illustrated in outlines in FIGS. 13 to 17.

It is particularly advantageous thereby that a setting is possible by means of the telescoping even if the holding rods 36 are used in predetermined length, thus for instance in their long form by using the first section 36a and the second section 36b. This is so because, in this case, the dispersing disk 5 can be set so that it assumes the desired height within the dispersing basket 2—for instance as a function of which maximum particle or agglomerate size is to be expected and has to be handled in the concrete case.

A further option can be seen quite well by means of these figures. The drive shaft 4 can be equipped with a centrifugal disk 38, which is arranged on said drive shaft directly above and outside of the dispersing basket 2. This centrifugal disk 38 ensures that no type of “dead water” is created, which does not flow or flows only weakly, on the top side of the dispersing basket 2 due to the closed or largely closed front side thereof, which would have the result in an unwanted manner that solid material to be dispersed accumulates on the top side of the dispersing basket and thus evades being dispersed.

FIGS. 17 to 20 show a third exemplary embodiment, which is modified under a certain technical aspect.

However, the statements already made above for the first and optionally also for the second exemplary embodiment also apply accordingly for this exemplary embodiment-unless stated otherwise expressly in the following description.

This exemplary embodiment is characterized in that a further, inner centrifugal disk 39 is provided—typically above the dispersing disk 5—thus a further or second centrifugal disk, respectively, which is embodied independently of the first centrifugal disk and which lies within the dispersing basket 2. This inner centrifugal disk contributes to the fact that the twist of the dispersing product within the dispersing basket 2 is enlarged even further. The collisions between the particles or agglomerates, respectively, and the discussed jacket of the dispersing basket are thus intensified, which intensifies the dispersing effect.

This inner centrifugal disk 39 can simultaneously also be used to seal the opening on the upper front side of the dispersing basket, through which the drive shaft 4 passes, or to at least protect it against surge release.

FIGS. 21 to 24 show a fourth exemplary embodiment, which is modified under a different technical aspect.

However, the statements already made above for the first and optionally also for the second and/or third exemplary embodiment also apply accordingly for this exemplary embodiment—unless stated otherwise expressly in the following description.

This exemplary embodiment is characterized in that the front-side cover of the dispersing basket, through which the drive shaft engages, likewise has a number of apertures, in addition to those, which the drive shaft allows to pass. The apertures provided here do not necessarily contribute directly to the comminution of particles or agglomerates. The main effect thereof is of an indirect nature. They ensure that dispersing product is also sucked in from the region above the dispersing basket, which tends to form a “dead water” and is conveyed into the dispersing basket, thus can no longer evade the comminution. Individually, the apertures are preferably ring section-shaped. Ideally, they are arranged on one or several circular paths, mostly concentrically to the drive shaft 4—one behind the other in a circumferential direction.

### VARIOUS MATTERS

For the sake of completeness, it is important to also mention that, if necessary, protection for a dispersing system (comprising a container holding the medium to be dispersed), which comprises a dispersing unit according to the invention, is claimed in the above-mentioned sense.

1. A dispersing unit for dispersing a feed material in a dispersant comprising a stationary dispersing basket, the jacket surface of which has outlet openings and the one front side of which is preferably—at least partially—closed and into which a shaft stub of a drive shaft protrudes, wherein, within the dispersing basket, the shaft stub carries a dispersing disk, which rotates during operation and thus sucks feed material-laden dispersant into the region between the dispersing disk and the closed front side of the dispersing basket and predominantly conveys it out of this region again via the outlet openings in the jacket surface of the dispersing basket, characterized in that the dispersing basket is open on its front side facing away from the drive shaft , and the clear radial distance between the outer circumference of the dispersing disk and the inner circumferential surface of the dispersing basket is so large that a gap is formed, via which a more than only insignificant portion of the dispersant conveyed into the dispersing basket can flow out of the dispersing basket again.

2. The dispersing unit according to claim 1, characterized in that the dispersing unit has a dip tube, in which the driven drive shaft can rotate, wherein the dip tube carries the dispersing basket.

3. A dispersing unit for dispersing a feed material in a dispersant comprising a dip tube, in which a motor-driven drive shaft can rotate, wherein the dip tube carries a stationary dispersing basket, the jacket surface of which has outlet openings, the front side of which facing the dip tube is closed and into which a shaft stub of the drive shaft protrudes, wherein the shaft stub carries a dispersing disk, characterized in that the dispersing basket is open on its front side facing away from the dip tube, that the height is significantly larger than the height of the dispersing disk and that the dispersing disk consists of a wheel body, which carries teeth on its outer circumference.

4. The dispersing unit according to claim 1, characterized in that the wheel body comprises spokes, preferably three pieces, in the region of the radially outer end of which teeth are attached.

5. The dispersing unit according to claim 1, characterized in that the wheel body comprises a plate-like wheel disk comprising notches, which provide for the passage of the dispersant, which is laden with feed material.

6. The dispersing unit according to claim 4, characterized in that the spokes or notches are positioned in the manner of blades, preferably at an angle of between 27° and 33° to the perpendicular on the drive shaft longitudinal axis, in such a way that they pump the dispersant essentially or at least predominantly in the direction of the drive shaft longitudinal axis.

7. The dispersing unit according to claim 4, optionally in connection with claim 6, characterized in that the ratio between the largest outer diameter of the dispersing disk, and the largest outer diameter, which describe the rotating exposed ends of the spokes, fulfills the following relationship: GAD/GAS=1.48 to 1.55.

8. The dispersing unit according to claim 1, characterized in that the continuous clear height of the outlet openings is more than only insignificantly larger than the height of the dispersing disk, ideally by at least the factor of 2.2, preferably by at least the factor of 4 and, in the optimal case, by at least the factor of 6.

9. The dispersing unit according to one of claim 3, characterized in that the clear radial distance between the outer circumference of the dispersing wheel and the inner circumferential jacket surface of the dispersing basket is so large that a gap is formed, via which a more than only insignificant portion of the dispersant conveyed into the dispersing basket can flow out of the dispersing basket again, preferably at least 15%, more preferably at least 25%.

10. The dispersing unit according to claim 1, characterized in that the dispersing basket is closed on its closed front side by a conical or parabolic reflector body.
Note: The upper limitation can be a flat disk, with or without apertures, bores, or the basket can also be open.

11. The dispersing unit according to claim 1, characterized in that the teeth are carried by a rim ring, with which they form a toothed ring, which is connected in a destruction-free replaceable manner to the spokes of the dispersing disk.

12. A dispersing system comprising a dispersing unit for dispersing a feed material in a dispersant having a stationary dispersing basket, the jacket surface of which has outlet openings and the one front side of which preferably—at least partially—closed to which shaft stub of a drive shaft protrudes, wherein, thin the dispersing basket, the shaft stub carries a dispersing disk, which rotates during operation and thus sucks feed material-laden dispersant into the region between the dispersing disk and the closed front side of the dispersing basket and predominantly conveys it out of this region again via the outlet openings in the jacket surface of the dispersing basket, characterized in that the dispersing bask et is open on its front side facing away from the drive shaft, and the clear radial dis between the outer circumference of the dispersing disk and the inner circumferential surface dispersing basket is so large that a gap is formed. via which a more than only insignificant portion of the dispersant conveyed into the dispersing basket can flow out of the dispersing basket again, characterized in that the dispersing system includes at least a second, alternatively mountable toothed ring, the teeth of which have a different tooth geometry than the teeth of the first toothed ring
and that the teeth are carried by a rim ring, with which they form a toothed ring, which is connected in a destruction-free replaceable manner to the spokes of the dispersing disk

13. A dispersing device comprising a dispersing unit for dispersing a feed material in a dispersant comprising a stationary dispersing basket, the jacket surface of which has outlet openings and the one front side of which is preferably—at least partially—closed and into which a shaft stub of a drive shaft protrudes, wherein, within the dispersing basket. the shaft stub carries a dispersing disk, which rotates during operation and thus sucks feed material-laden dispersant into the region between the dispersing disk and the closed front side of the dispersing basket and predominantly conveys it out of this region again via the outlet openings in the jacket surface of the dispersing basket. characterized in that the dispersing basket is open on its front side facing away from the drive shaft, and the clear radial distance between the outer circumference of the dispersing disk and the inner circumferential surface of the dispersing basket is so large that a gap is formed, via which a more than only insignificant portion of the dispersant conveyed into the dispersing basket can flow out of the dispersing basket again, characterized in that the dispersing device has a high-speed drive, which allows the dispersing disk to rotate at a speed of more than 18 m/s and ideally up to 20 m/s in the region of its outer circumference.

14. The dispersing device according to claim 13, characterized in that the dispersing device has a dispersing container, which holds the dispersant and the feed material and into which the dispersing basket is completely immersed during operation, characterized in that the outer diameter of the dispersing basket is 0.5-times to 0.6-times the inner diameter of the dispersing container.

15. The dispersing unit according to claim 3, characterized in that the wheel body comprises spokes, preferably three pieces, in the region of the radially outer end of which teeth are attached.

16. The dispersing unit according to claim 3, characterized in that the wheel body comprises a plate-like wheel disk comprising notches, which provide for the passage of the dispersant, which is laden with feed material.

17. The dispersing unit according to claim 3, characterized in that the continuous clear height of the outlet openings is more than only insignificantly larger than the height of the dispersing disk, ideally by at least the factor of 2.2, preferably by at least the factor of 4 and, in the optimal case, by at least the factor of 6.

18. The dispersing unit according to claim 3, characterized in that the dispersing basket is closed on its closed front side by a conical or parabolic reflector body.
Note: The upper limitation can be a flat disk, with or without apertures, bores, or the basket can also be open.

19. The dispersing unit according to claim 3, characterized in that the teeth are carried by a rim ring, with which they form a toothed ring, which is connected in a destruction-free replaceable manner to the spokes of the dispersing disk.
